(19) United States
(12) Patent Application Publication
(10) Pub. No.: US 2006/0096999 A1
(43) Pub. Date: May 11, 2006

(54) Adhesive label dispenser

(75) Inventors: Alex Horng, Kaohsiung (TW); Kuo-Cheng Chen, Kaohsiung (TW); Ming-Che Wu, Kaohsiung (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung (TW)

(21) Appl. No.: 11/029,358

(22) Filed: Jan. 6, 2005

(30) Foreign Application Priority Data
Nov. 10, 2004 (TW) 93134322

(51) Int. Cl. B65H 5/28; G07F 11/68

(52) U.S. Cl. 221/73

(57) ABSTRACT

An adhesive label dispenser includes a drive unit for moving a carrier sheet with adhesive labels thereon, a support plate for guiding the carrier sheet, a conveying mechanism driven by the drive unit, and a sensor unit. The support plate includes a label output end at which the carrier sheet bends downward, freeing the adhesive labels from the carrier sheet. The conveying mechanism is located below the label output end. The conveying mechanism conveys the adhesive labels freed from the carrier sheet to an output end for fetch. The sensor unit detects whether one of the adhesive labels freed from the carrier sheet has reached a predetermined position and sends a signal for stopping or activating the drive unit.

### BACKGROUND OF THE INVENTION

1. Field of the Invention

The present invention relates to a dispenser. In particular, the present invention relates to an adhesive label dispenser.

2. Description of Related Art

U.S. Pat. No. 4,194,646 discloses a manually operated label dispensing machine for receiving web-forming backing material carrying readily detachable, adhesive-coated labels thereon. The dispensing machine comprises a support plate having a discharge edge for effecting freeing the labels from the backing material. The dispensing machine further comprises a drive roller carried upon a drive shaft for cooperating with a driven roller for gripping therebetween the backing material, causing pulling of the same about the discharge edge. The drive roller is mounted for rotation by manually applied torque, and the driven roller is supported upon a swing frame for selected disposition in either operative relationship with the drive roller or in inoperative condition. A worker may fetch the labels easily upon turning of a control knob.

Although the manually operated label dispensing machine simplifies freeing of the labels from the backing material, the worker has to not only fetch and put the labels onto the desired positions but also manually turn the control knob in a mass-production line. If the worker fails to turn the control knob in time or even forgets to turn the control knob, or the torque applied to the control knob is too large or too small, the working smoothness of the production line is adversely affected.

### OBJECTS OF THE INVENTION

An object of the present invention is to provide an adhesive label dispenser that improves convenient fetch of the labels.

Another object of the present invention is to provide an adhesive label dispenser that conveys adhesive labels departing from a carrier sheet to a predetermined position, providing a semi-automatic operation.

### SUMMARY OF THE INVENTION

An adhesive label dispenser in accordance with the present invention comprises a drive unit for moving a carrier sheet with adhesive labels thereon, a support plate for guiding the carrier sheet, a conveying mechanism driven by the drive unit, and a sensor unit.

The support plate includes a label output end at which the carrier sheet bends downward, freeing the adhesive labels from the carrier sheet. The conveying mechanism is located below the label output end. The conveying mechanism conveys the adhesive labels freed from the carrier sheet to an output end for fetch. The sensor unit detects whether one of the adhesive labels freed from the carrier sheet has reached a predetermined position and sends a signal for stopping or activating the drive unit.

Preferably, the conveying mechanism includes a drive shaft, a driven shaft and at least two conveying bands mounted around the driven shaft and the driven shaft for conveying the adhesive labels to the output end of the driven shaft. Preferably, each of the drive shaft and the driven shaft includes a plurality of annular grooves. The at least two conveying bands are selectively mounted around at least two of the annular grooves of the drive shaft and at least two of the annular grooves of the driven shaft. The sensor unit is mounted on an outer side or an inner side of the driven shaft.

Preferably, the label output end of the support plate includes a leading edge for guiding the carrier sheet downward.

Preferably, the drive unit comprises a motor, a drive shaft, a driven shaft and a gear train for moving the carrier sheet and driving the conveying mechanism.

The adhesive label dispenser may further include a pressing unit for pressing the carrier sheet against the driven shaft of the drive unit for assuring driving of the carrier sheet by the driven shaft of the drive unit. Preferably, the pressing unit includes a pivotable rocker arm having a first end and a second end, a pressing roller fixed to the first end of the rocker arm to move therewith, and an elastic element having an end fixed to the second end of the rocker arm for biasing the pressing roller to press against the driven shaft of the drive unit. The pressing unit may further include a handle on the pressing roller to allow manual operation for moving the pressing roller away from the driven shaft of the drive unit.

Other objects, advantages and novel features of this invention will become more apparent from the following detailed description when taken in conjunction with the accompanying drawings.

### BRIEF DESCRIPTION OF THE DRAWINGS

FIG. 1 is a perspective view of an adhesive label dispenser in accordance with the present invention;

FIG. 2 is a schematic sectional view of the adhesive label dispenser in accordance with the present invention;

FIG. 3 is a sectional view taken along plane 3-3 in FIG. 2;

FIG. 4 is a view similar to FIG. 3, wherein the adhesive label dispenser is used with wider labels;

FIG. 5 is a view similar to FIG. 2, wherein an adhesive label is conveyed to a predetermined position; and

FIG. 6 is a sectional view similar to FIG. 2, illustrating use of the adhesive label dispenser with smaller labels;

FIG. 7 is a sectional view taken along plane 7-7 in FIG. 6.

### DETAILED DESCRIPTION OF THE PREFERRED EMBODIMENTS

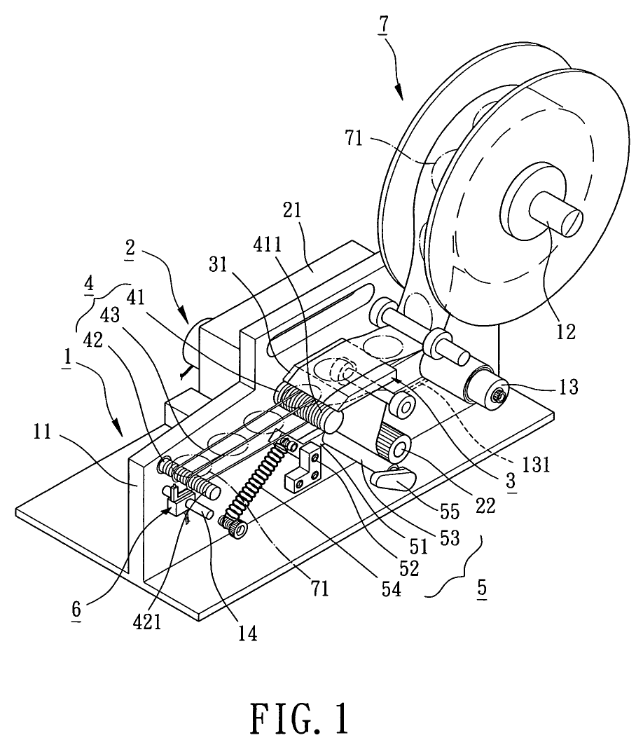

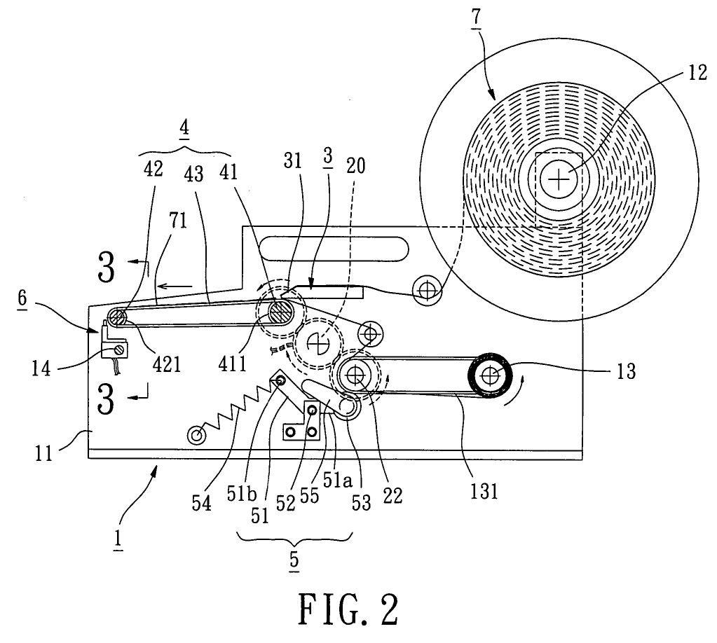

Referring to FIGS. 1 and 2, an adhesive label dispenser in accordance with the present invention comprises a base 1, a drive unit 2, a support plate 3, a conveying mechanism 4, a pressing unit 5, and a sensor unit 6. A plurality of adhesive labels 71 are carried on a carrier sheet 7 that is fed by the conveying mechanism 4 to a predetermined position, allowing easy fetch of the adhesive labels 71 through easy operation.

A first reel 12, a second reel 13, and a support member 14 are mounted on a mounting wall 11 that stands upright from the base 1. The carrier sheet 7 with adhesive labels 71 thereon is wound around the first reel 12, and the second reel 13 is used to recycle the carrier sheet 7 after the adhesive labels 71 have been removed. The support member 14, the first reel 12, and the second reel 13 are mounted on the same side (a first side) of the mounting wall 11. The senor unit 6 is pivotally mounted on the support member 14. The drive unit 2 includes a drive shaft 20, a gear train housed in a gear box 21, and a driven shaft 22 that is driven by the drive shaft 20 via transmission by the gear train. The second reel 13 is driven by the driven shaft 22 via, e.g., an endless belt 131.

Still referring to FIGS. 1 and 2, the support plate 3 is in the form of a planar stage and mounted to the first side of the mounting wall 11. The support plate 3 is located between the first reel 12 and the second reel 13 and includes a label input end and a label output end. The label output end of the support plate 3 includes a leading edge 31 for guiding the carrier sheet 7 downward, allowing easy freeing of the labels 71 from the carrier sheet 7.

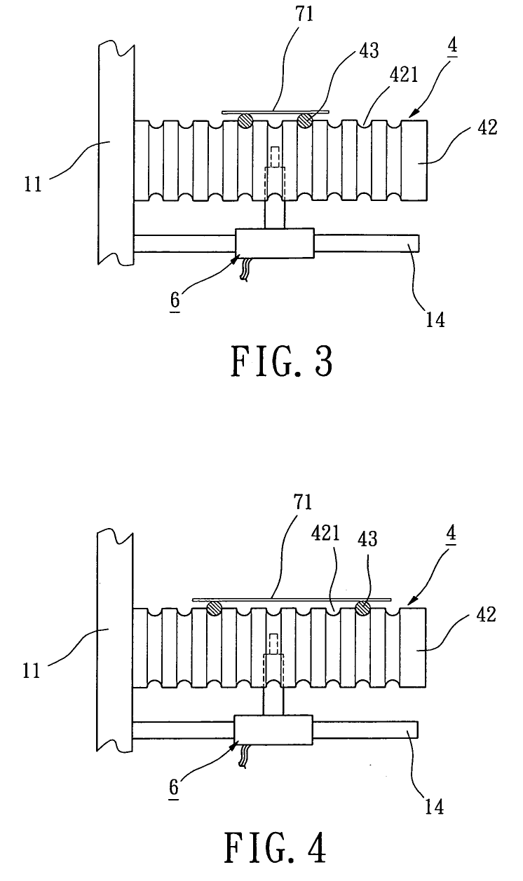

The conveying mechanism 4 is also mounted on the first side of the mounting wall 11. The conveying mechanism 4 comprises a drive shaft 41, a driven shaft 42, and at least two conveying bands 43. The drive shaft 41 is driven by the gear train of the drive unit 2 and located below the leading edge 31 of the support member 3. The drive shaft 41 includes a plurality of annular grooves 411, and the driven shaft 42 includes a corresponding number of annular grooves 421 (see FIG. 3). In the illustrated embodiment, two conveying bands 43 are respectively mounted around two annular grooves 411 of the drive shaft 41 and two associated annular grooves 421 of the driven shaft 42. Each conveying band 43 is preferably an elastic band for transmitting power from the drive shaft 41 to the driven shaft 42 and for conveying the adhesive labels 71 that has been freed from the carrier sheet 7 to the predetermined position.

Still referring to FIGS. 1 and 2, the pressing unit 5 comprises a rocker arm 51, a pivot shaft 52, a pressing roller 53, an elastic element 54, and a handle 55 mounted on the pressing roller 53 to move therewith. In the illustrated embodiment, the rocker arm 51 is substantially V-shaped and includes an intermediate portion pivotally mounted to the mounting wall 11 via the pivot shaft 52. The elastic element 53 includes a first end fixed to the mounting wall 11 and a second end fixed to an end 51b of the rocker arm 51. The other end 51a of the rocker arm 51 is fixed to the pressing roller 53 to move therewith. Thus, the pressing roller 53 is biased by the elastic element 54 to press against the driven shaft 22. The handle 55 can be manually operated to pivot the rocker arm 51 and to temporarily separate the pressing roller 53 from the driven shaft 22, allowing easy installation of the carrier sheet 7.

The sensor unit 6 preferably includes an infrared sensor. The sensor unit 6 is pivotally mounted on the support member 14 fixed on the mounting wall 11. Preferably, the sensor unit 6 is located on an output end of the driven shaft 42 for detecting whether the driven shaft 42 has conveyed the adhesive label 71 to the predetermined position.

In use, the carrier sheet 7 with adhesive labels 71 is wound around the first reel 12. A distal end of the carrier sheet 7 is guided across an upper side of the support plate 3 and passes through the leading edge 31 at which the carrier sheet 7 is bent downward and then passes through a gap between the driven shaft 22 and the pressing roller 53. Thus, the carrier sheet 7 is moved when the driven shaft 22 is turned. The carrier sheet 7 without adhesive labels 71 is wound around the second reel 13. As mentioned above, the adhesive labels 71 on the carrier sheet 7 separates from the carrier sheet 7 at the bending point of the carrier sheet 7. The adhesive labels 71 are then stuck to and conveyed by the conveying bands 43.

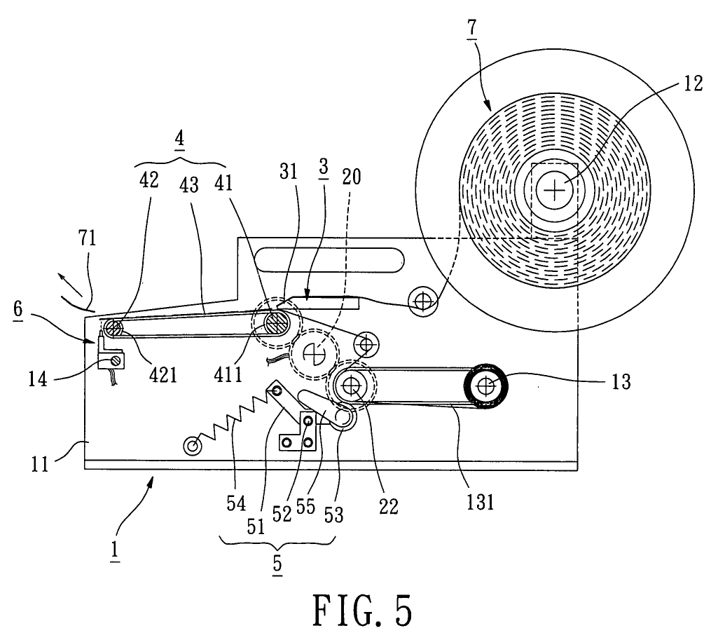

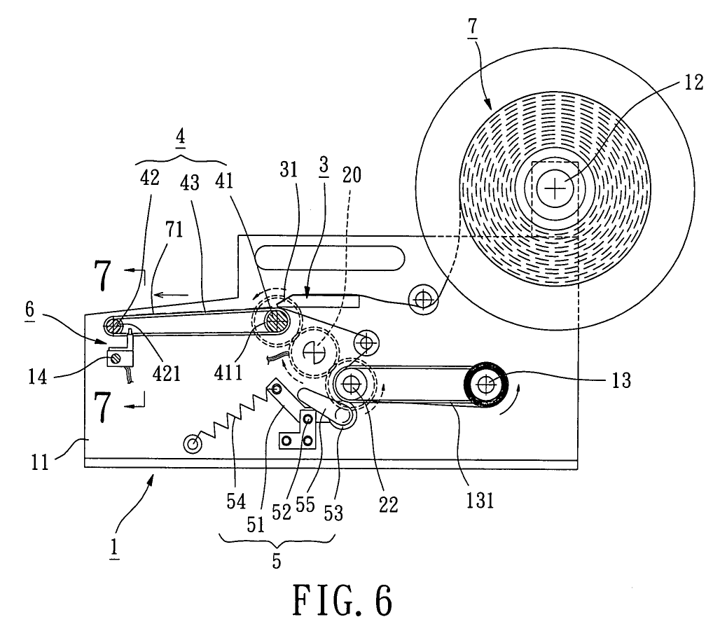

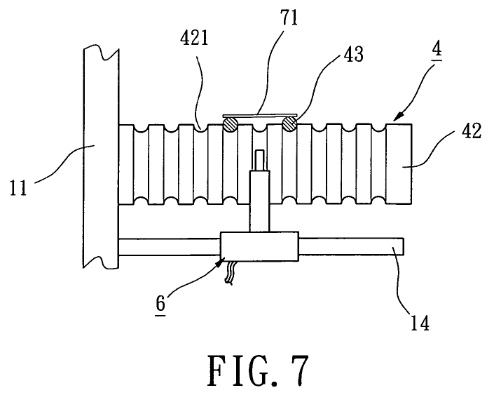

Referring to FIGS. 3 and 5, when an adhesive label 71 is conveyed by the conveying bands 43 to the predetermined position (i.e., the output end of the driven shaft 42) and detected by the sensor unit 6, a signal is sent to stop the drive unit 2. The adhesive label 71 remains on the output end of the driven shaft 42 for fetch and use. Once the adhesive label 71 is removed from the output end of the driven shaft 42, no adhesive label 71 is detected by the sensor unit 6. At this time, the sensor unit 6 sends another signal to activate the drive unit 2 until another adhesive label 71 is conveyed to the output end (the predetermined position) of the driven shaft 42.

Referring to FIG. 4, in a case that the adhesive labels 71 are wider, the conveying bands 43 are mounted in another two annular grooves 411 of the drive shaft 41 and another two annular grooves 421 of the driven shaft 42 that are spaced greater. Thus, the adhesive label dispenser in accordance with the present invention can be used with adhesive labels of different widths.

In a case that the adhesive label dispenser is used with adhesive labels of a smaller size, the sensor unit 6 can be mounted in an inner side of the driven shaft 42 to assure that the sensor unit 6 reliably detects the adhesive labels 71 at the predetermined position for fetch by the worker.

As apparent from the forgoing description, the adhesive label dispenser in accordance with the present invention can precisely convey the adhesive labels 71 to the predetermined position without manual operation by the worker. Fetch of the adhesive labels 71 is more convenient.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. An adhesive label dispenser, comprising:
a drive unit for moving a carrier sheet with adhesive labels thereon;
a support plate for guiding the carrier sheet, the support plate including a label output end at which the carrier sheet bends downward, freeing the adhesive labels from the carrier sheet;
a conveying mechanism driven by the drive unit and located below the label output end, the conveying mechanism conveying the adhesive labels freed from the carrier sheet to an output end for fetch; and
a sensor unit for detecting whether one of the adhesive labels freed from the carrier sheet has reached a predetermined position and sending a signal for stopping or activating the drive unit.

2. The adhesive label dispenser as claimed in claim 1, wherein the conveying mechanism includes a drive shaft, a driven shaft and at least two conveying bands mounted around the driven shaft and the driven shaft for conveying the adhesive labels to the output end of the driven shaft.

3. The adhesive label dispenser as claimed in claim 2, wherein each of the drive shaft and the driven shaft includes a plurality of annular grooves, said at least two conveying bands being selectively mounted around at least two of the annular grooves of the drive shaft and at least two of the annular grooves of the driven shaft.

4. The adhesive label dispenser as claimed in claim 2, wherein the sensor unit is mounted on one of an outer side and an inner side of the driven shaft.

5. The adhesive label dispenser as claimed in claim 1, wherein the label output end of the support plate includes a leading edge for guiding the carrier sheet downward.

6. The adhesive label dispenser as claimed in claim 1, wherein the drive unit comprises a motor, a drive shaft, a driven shaft and a gear train for moving the carrier sheet and driving the conveying mechanism.

7. The adhesive label dispenser as claimed in claim 6, further comprising a pressing unit for pressing the carrier sheet against the driven shaft of the drive unit for assuring driving of the carrier sheet by the driven shaft of the drive unit.

8. The adhesive label dispenser as claimed in claim 7, wherein the pressing unit includes a pivotable rocker arm having a first end and a second end, a pressing roller fixed to the first end of the rocker arm to move therewith, and an elastic element having an end fixed to the second end of the rocker arm for biasing the pressing roller to press against the driven shaft of the drive unit.

9. The adhesive label dispenser as claimed in claim 8, wherein the pressing unit further includes a handle on the pressing roller to allow manual operation for moving the pressing roller away from the driven shaft of the drive unit.
